(19) United States
(12) Patent Application Publication
(10) Pub. No.: US 2007/0069015 A1
(43) Pub. Date: Mar. 29, 2007

(54) Payment terminals

(75) Inventors: Richard N. Vernon, Hainault (GB); Grant Ahlrichs, Linslade (GB)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/509,962

(22) Filed: Aug. 25, 2006

(30) Foreign Application Priority Data
Sep. 25, 2005 (GB) 0519519.3

(51) Int. Cl. G06K 15/00; G07F 19/00; G06F 7/08

(52) U.S. Cl. 235/383; 235/379; 235/381

(57) ABSTRACT

A system of processing a payment transaction for goods and/or services, the system comprising a kiosk for providing the goods and/or services, a payment application and a payment terminal. The kiosk includes a kiosk application and a data store for storing data in respect of the transaction. The payment application is adapted to read data from the data store and communicate with the payment terminal, the payment terminal being computationally separate from the kiosk application and adapted to contact a financial processor and communicate back to the data store. The kiosk application monitors the data returning from the payment terminal and acts accordingly.

### FIELD OF THE INVENTION

The invention relates to the field of stand alone kiosks.

### BACKGROUND OF THE INVENTION

There are many kiosk devices that provide goods or services to customers. When payment is required for these goods or services the options are for a member of store staff to take payment, a mechanism for the kiosk to take cash payment or a mechanism for the kiosk to take payment via a payment card (credit card, debit card, prepayment cards etc).

One of the key benefits of a kiosk device is that it allows the customer to be autonomous in the selection of goods or services, with no involvement required of store staff. Involving store staff in the payment process disrupts the customer workflow and causes inconvenience to the store. There will also be situations where store staff do not exist, e.g. a railway station or shopping mall.

A kiosk with a mechanism to accept coins and notes overcomes a number of these problems but adds security requirements. These include the need to maintain levels of change in the mechanism and the need to empty the machine of cash on a routine basis.

A kiosk that accepts payment via a payment card overcomes all these problems and allows a kiosk to be truly self-service in any environment. Further, the ability to accept payment via a credit or debit card does not require the customer to purchase or add funds to a ‘pre-payment’ card.

### Problem to be Solved by the Invention

Current methods of enabling a cashless, self-service, unattended kiosk with credit/debit card payment involve integration of a card payment terminal 4 with a kiosk device 5, see FIG. 1. The terminal is controlled by the kiosk via an Application Program Interface (API) 8 or Software Development Kit (SDK) supplied by the payment terminal manufacturer. The API/SDK is integrated into the original kiosk core application 1 and the resulting software code compiled into a single application so that the payment terminal 4 is controlled from within the core kiosk application.

As a result, the kiosk device plays an integral role in handling the payment transaction with the acquiring bank. This causes the kiosk/payment terminal combination to require mandatory certification by the acquiring bank before deployment is permitted. In order to obtain certification, the solution must be documented, tested and then approved by the certifying body. These all add time and cost to the deployment of a payment solution.

In many countries, the solution must be re-certified by different acquiring banks before they will accept financial transactions. Additionally, if the integrated payment terminal is not suitable for use in some countries, for connection to some banks, or not the preferred terminal of the retailer, a new payment terminal must be used.

A different payment terminal may well have a different SDK or set of APIs. This will then require a re-working of elements of the core kiosk application to integrate the new APIs. As the kiosk application is an active part of the transaction processing, and any changes in the handling of a transaction require approval from the banking authorities, this new system of the re-compiled kiosk application and alternate payment terminal are again subject to banking approval and the associated effort, documentation, cost and time.

### SUMMARY OF THE INVENTION

The present invention is directed towards a method and system of processing a payment at a kiosk in which the kiosk itself does not pay an active part in the transaction process and therefore does not require certification, regardless of the country, payment terminal or acquiring bank.

According to the present invention there is provided a system of processing a payment transaction for goods and/or services, the system comprising a kiosk for providing the goods and/or services, a payment application and a payment terminal, the kiosk including a kiosk application and a data store for storing data in respect of the transaction, the payment application being adapted to read data from the data store and communicate with the payment terminal, the payment terminal being computationally separate from the kiosk application and adapted to contact a financial processor and communicate back to the data store, the kiosk application being adapted to monitor the data returning from the payment terminal and act accordingly.

The invention further provides a method of processing a payment transaction for goods and/or services provided by a kiosk, the kiosk including a kiosk application and a data store, the method comprising the steps of storing data in respect of the transaction in the data store, reading data from the data store and communicating said data to a payment terminal which is computationally separate from the kiosk application, contacting a financial processor, communicating further data from the financial processor to the data store via the separate payment terminal and monitoring the further data in the data store, the kiosk application acting in accordance with the monitored data.

### Advantageous Effect of the Invention

As the kiosk passes only the transaction value, together with some reference information not critical to the transaction, to the payment terminal and does not print a financial receipt itself the kiosk does not require certification by acquiring banks, which are solely concerned with the integrity of the financial transaction. As the transaction value and the success/failure codes are passed via text files no device dependent development work is required. The cost and work involved in enabling the kiosk device to handle a transaction are therefore significantly reduced.

The payment application/payment terminal combination is indifferent to the nature of the kiosk application that creates the transaction request data. This has the additional benefit that once a payment application/payment terminal combination has been developed and certified for use by an acquiring bank, it may be used to enable payment handling for any kiosk application that is capable of writing the necessary data to the data store in the manner expected by the payment application. The result of a single development effort may be applied to any number of devices for which it may not have been commercially viable to develop individual payment handling solutions.

### BRIEF DESCRIPTION OF THE DRAWINGS

The invention will now be described with reference to the accompanying drawings in which;

FIG. 1 illustrates a system in accordance with the prior art;

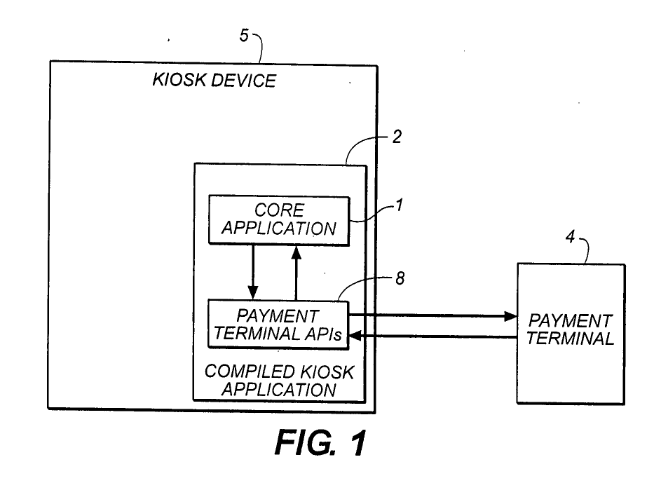

FIG. 2 illustrates a system according to one embodiment of the invention; and

FIG. 3 illustrates a system according to a second embodiment of the invention.

### DETAILED DESCRIPTION OF THE INVENTION

To remove the need for the kiosk and its compiled application to be involved in the certification process, it is necessary to dissociate the payment terminal from the kiosk application whilst maintaining the desired payment handling function of the kiosk.

The method to enable this is to make the necessary data for a transaction available to a separate payment application that is not part of the compiled kiosk application, rather than communicate directly with the payment terminal from within the compiled kiosk application. This separate payment application may reside on the same device (e.g. PC) as the main kiosk application or a separate device (e.g. another PC or the payment terminal itself). The combination of the payment application and payment terminal must then be able to read the data, process the transaction with the acquiring bank and make available the necessary data for the kiosk application to continue its normal functions.

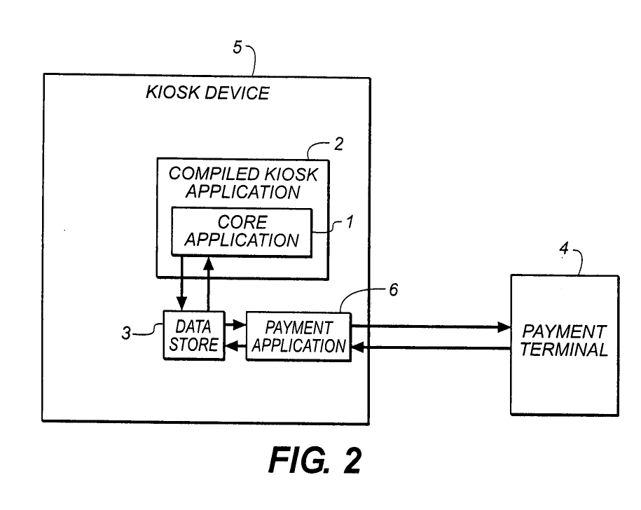

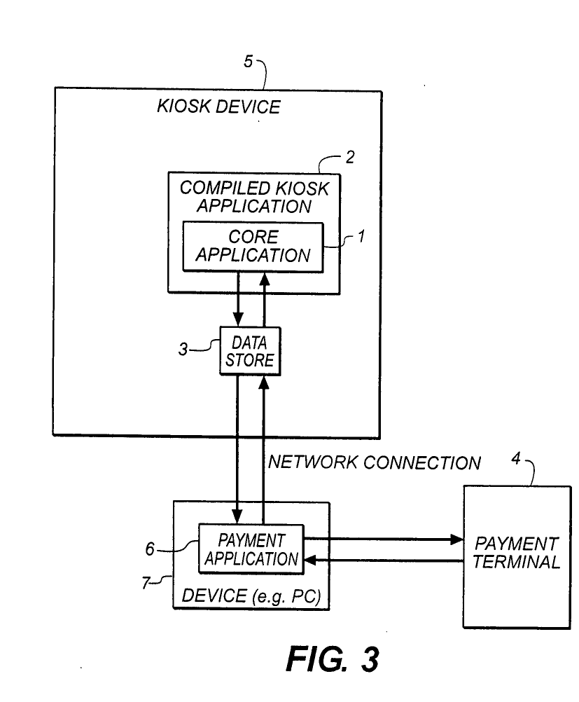

An embodiment of the invention is shown diagrammatically in FIG. 2. Data is held in a data store 3 accessible by both the compiled kiosk application 2 and the separate payment application 6. In this case, the payment application resides on the same device as the kiosk application. In FIG. 3 an alternative embodiment is shown where the payment application resides on a separate device and the data store is accessed via a network connection.

When the kiosk application needs to receive a payment to continue, the necessary data (e.g. order value, currency, language, reference string etc.) is written to the data store, presented in a manner expected by the payment application (e.g., formatted text file, database file etc.). The payment application 6 reads this information and, in combination with the payment terminal 4, progresses the transaction. The combination of the payment application/payment terminal returns the status of the transaction to the data store (e.g. success, fail, card not accepted) presented in the manner expected by the kiosk application. The kiosk application then continues with its function in the appropriate way, dependent on the information returned.

It will be understood that even if the payment terminal is physically integrated with the kiosk it is no longer computationally integrated with the kiosk application. The kiosk application 2 is not part of the transaction handling process. The kiosk application 2 only requests a transaction and receives a transaction status by return. Consequently, the mandatory certification required by the acquiring banks applies only to the payment application and payment terminal combination. The kiosk application also needs no modifications for changes in country placement, payment terminal or acquiring bank. Any changes that may be required to the solution will be limited to the payment application and payment terminal.

The invention will now be illustrated by an example.

### EXAMPLE

In the example system, the vending machine is a Kodak Picture Maker, see U.S. Pat. No. 5,664,253. The Kodak Picture Maker is a machine that has a customer interface that allows the input and selection of images and then provides the customer with an output of their chosen images in any of a number of forms. The output may be on silver halide material, optical media or more commonly thermal media (dye sublimation paper). There is no restriction on media output type.

It is common to require this type of machine to be modified for self-service or unattended use for many or all of the reasons explained previously. The preferred method to achieve this is to accept electronic payment, either by credit or debit card. Currently, a ‘Chip and PIN’ initiative is being driven across Europe by EuroPay, Mastercard and Visa (EMV). This requires that unattended devices such as the Picture Maker must be capable of accepting a Chip and PIN card, increasing the complexity of any solution, as the legacy systems based on magnetic stripe technology become unacceptable for unattended applications by the acquiring banks.

Once a customer has compiled their order on the Picture Maker they are prompted for their preferred payment, if the retailer has chosen to allow such a choice. The retailer may choose to only allow electronic payment via a payment card. The Picture Maker kiosk application then creates a file in a known location on the kiosk hard drive (though this may be located elsewhere). This file contains certain data expected by the payment application, namely the transaction amount, the currency (communicated via the country ISO code) and a reference string.

The payment application routinely looks to the specified location on the hard drive and when a correctly named file appears, opens the file and reads the contents. The payment application then communicates in the necessary manner with the payment terminal to initiate a payment request for the desired amount. The payment terminal handles the financial transaction entirely. The terminal prompts the user/customer to enter their PIN or swipe the card (if there is no Chip present on the card), communicates with the acquiring bank and, if successful, prints out a receipt for the user (if required), complete with the reference string. At the same time, the terminal also communicates data back to the payment application which then writes data back to a file in a known location. This data contains a success/failure code and data that can assist (though not limited to) payment tracking. The Picture Maker kiosk application will monitor the known location and will interrogate the returned file for the success/failure code and act accordingly, by releasing the print job on success or requiring an alternative card or payment method on failure. The additional data returned can be placed into a ‘journal’ to facilitate order tracking, point of sale integration and be used to defend against “chargebacks”.

In addition to the use of a data store to hold the data necessary to enable the handling of a financial transaction, a similar approach could be used to hold more detailed customer order and transaction data that may be required for a ‘Electronic Point-of-Sale’ (EPOS) system integration. Similar to the complications described previously, integration into an EPOS system can be complicated and require significant effort for certification before deployment. The data store could store file(s) with data held in a manner capable of being read by an EPOS system or an application designed to incorporate data into an EPOS system. The extent of the integration with the EPOS system could range from “full” integration where the EPOS system handles the entire financial transaction (rather than the payment terminal described previously), or be limited to the incorporation of data to be used for inventory control, stock management and financial tracking.

It will be understood that the invention is not limited to imaging kiosks but can be used for any vending kiosk in which payment must be made for goods and/or services.

The invention has been described in detail with reference to preferred embodiments thereof. It will be understood by those skilled in the art that variations and modifications can be effected within the scope of the invention.

1. A system of processing a payment transaction for goods and/or services, the system comprising a kiosk for providing the goods and/or services, a payment application and a payment terminal, the kiosk including a kiosk application and a data store for storing data in respect of the transaction, the payment application being adapted to read data from the data store and communicate with the payment terminal, the payment terminal being computationally separate from the kiosk application and adapted to contact a financial processor and communicate back to the data store, the kiosk application being adapted to monitor the data returning from the payment terminal and act accordingly.

2. A system according to claim 1 wherein the payment application is located in the same device as the kiosk application.

3. A system according to claim 1 wherein the payment application is located in a device separate to the kiosk application.

4. A system as claimed in claim 1 wherein the data is further used for inventory control, stock management and/or financial tracking.

5. A system as claimed in claim 1 wherein the kiosk is an imaging apparatus for providing hard copy prints.

6. A method of processing a payment transaction for goods and/or services provided by a kiosk, the kiosk including a kiosk application and a data store, the method comprising the steps of storing data in respect of the transaction in the data store, reading data from the data store and communicating said data to a payment terminal which is computationally separate from the kiosk application, contacting a financial processor, communicating further data from the financial processor to the data store via the separate payment terminal and monitoring the further data in the data store, the kiosk application acting in accordance with the monitored data.

7. A method as claimed in claim 6 wherein the data is further used for inventory control, stock management and/or financial tracking.

8. A kiosk for providing goods and/or services on payment, the kiosk including a kiosk application and a data store and being adapted for communication with a payment terminal, computationally separate to the kiosk application, by means of a payment application.

9. A kiosk as claimed in claim 8 wherein the kiosk is an imaging apparatus for providing hard copy prints.
